(19) United States
(12) Patent Application Publication
(10) Pub. No.: US 2012/0262922 A1
(43) Pub. Date: Oct. 18, 2012

(54) STREET LAMP WITH HIGH-POWER SINGLE POLYCRYSTALLINE LED CHIP MODULE

(76) Inventors: Jansen Yang, Suzhou (CN); Hong Chen, Shanghai (CN)

(21) Appl. No.: 13/386,088

(22) PCT Filed: Jul. 29, 2010
(86) PCT No.: PCT/CN10/75567

§ 371 Date: Jan. 20, 2012

(30) Foreign Application Priority Data
Aug. 3, 2009 (CN) 200910109062.5

(51) Int. Cl. F21V 29/00; F21V 5/04

(52) U.S. Cl. 362/268

(57) ABSTRACT

A street lamp with high-power single polycrystalline Light-Emitting Diode (LED) chip module comprises a shell composed of a back shell and a front shell provided with a first window, an optical field cover mounted on the first window of the shell, a high-power single polycrystalline LED chip module, a light scattering lens mounted in the opening at the bottom of the optical field cover, wherein the light scattering lens is a solid lens using a flat bottom surface as a light incident surface, and the bottom surface is close jointed to the silica gel of the high-power single polycrystalline LED chip module without interspaces, so as to form a bat wing shaped rectangle light distribution curve of an optical field using a primary light source, and a radiating device mounted on the arched portion of the back shell and including an arc radiator and super heat-conductive pipes. The high-power single polycrystalline LED chip module, which is used as the light source, cooperates with the optical field cover and the single light scattering lens to form a bat wing shaped rectangle light distribution curve of an optical field using a primary light source, increase the brightness uniformity, and obtain a better illumination effect.

### TECHNICAL FIELD OF THE INVENTION

The disclosure relates to an illuminating street lamp, in particular to a street lamp with high-power single polycrystalline Light-Emitting Diode (LED) chip module for illumination.

### BACKGROUND OF THE INVENTION

Conventional road illumination generally adopts high pressure sodium lamp, which has defects of short service life and high energy consumption; therefore, the solid state lighting LED street lamp developed by people and the present high-power LED street lamp have serious problems of heat dissipation, luminous efficacy and luminous attenuation which can not be solved all the time. The high-power single polycrystalline LED chip module in particular has more serious problems and further has a problem of distribution light curve, that is, bat wing shaped rectangular optical field, which can not solve the rectangular optical field using a primary light source but must use the third light source of a reflector to obtain a little improvement; thus the luminous efficacy is seriously reduced.

Although there is so called LED street lamp illuminating a demonstration road at present, chip modularization can not be adopted to manufacture a street lamp due to the problems of bad heat dissipation effect and poor distribution light curve. The present LED street lamp uses the LED of 1-watt to 5-watt to constitute a 100-watt or 50-watt super sized radiating fin by arranging 100 to 20 or 50-10 LEDs to manufacture a lamp. The radiator of the present 100-watt LED street lamp adopts an aluminium block or an aluminium alloy shell of more than 10 Kg to radiate heat so as to solve the problem of heat dissipation. However, the LED street lamp formed by arranging a plurality of LEDs has bad light condensation effect; even though a condenser mirror is used to condense light, the luminous efficiency is weakened by about 20%.

At present, the high-power LED street lamp adopting the design scheme of primary light source, in particular the street lamp with high-power single polycrystalline LED chip module, is not disclosed in relevant reference.

### SUMMARY OF THE INVENTION

In view of the defect existing in the present LED street lamp technology, the disclosure provides a street lamp with high-power single polycrystalline LED chip module with light weight, small volume and fine radiation effect, which can realize bat wing shaped rectangular optical field using a primary light source, increase the brightness uniformity and improve the illumination effect.

In order to achieve the purpose above, the street lamp with high-power single polycrystalline chip module of the disclosure comprises:

a shell composed of a back shell and a front shell, wherein the front shell is provided with a first window, the middle part of the back shell is a circular arched portion protruding outwards and the arched portion is provided with a second window;

an optical field cover, which is mounted on the first window inside the shell or forms a plastic member with the front shell directly through injection technique and comprises a fan shaped body, wherein a flat trumpet shaped cavity with openings at two ends is provided inside the fan shaped body;

a high-power single polycrystalline LED chip module;

a light scattering lens mounted in the opening at the inner bottom of the optical field cover, wherein the light scattering lens is a solid lens using a flat bottom surface as a light incident surface, and the bottom surface is close jointed to the silica gel on the surface of the high-power single polycrystalline LED chip module without interspaces, so as to form a bat wing shaped rectangle light distribution curve of an optical field using a primary light source; and

a radiating device, which comprises

an arc radiator mounted on the arched portion of the back shell, with radiating fins covered on an outside arc surface in a divergent shape;

a heat-conductive component in close contact with the back surface of the high-power single polycrystalline LED chip module; and

at least one super heat-conductive pipe located inside the second window of the shell, with two ends respectively connected with the heat-conductive component and the arc radiator.

The radiating device further comprises a connection frame fixedly mounted surrounding the arc plate of the arc radiator; the lower end face of the connection frame is provided with a plurality of first downward pins at intervals; the periphery of the circular arched portion inside the back shell is provided with a plurality of first hollow columns for accommodating and mounting the corresponding first pins on the connection frame. Upon assembly, the connection frame is in close contact with the arched portion of the back shell; the plurality of first pins on the connection frame is correspondingly inserted into the plurality of first hollow columns of the back shell, wherein screws are screwed into the first pins of the connection frame at the bottom end of the first hollow column to fasten the arc radiator; in this way, the mounting screws all are located inside the shell and would not be rusted due to raining.

Further, the arc radiator consists of at least one radiator member, each radiator member including an arc plate, wherein a plurality of spaced radiating fins is extended outwards from the outside arc surface of the arc plate; a vertical end face of the arc plate is provided with a connection groove along the longitudinal direction while the other vertical end face is provided with a connection protruded strip along the longitudinal direction; at least one heat-conductive pipe mounting hole is set on the arc plate along the longitudinal direction. In this way, one or more identical radiator members can be used to assemble radiators suitable for the LED street lamps with different powers, thus the radiator module is singularized and it is unnecessary to develop a radiator module for each type of LED with a different power; therefore, the expense of module is saved.

Further, the radiating fin can be made as one having a thick bottom and a thin top and having protruding strips covered on the surface; in this way, the superficial area of the radiating fin can be increased greatly, thus the radiating efficiency is improved; besides, the distance between adjacent radiating fins can be increased to enhance the air circulation between radiating fins so as to accelerate the dissipation of heat.

The optical field cover comprises a fan shaped body, wherein a flat trumpet shaped cavity is provided inside the fan shaped body. An embedding portion matched with the first window on the front shell is extended outwards from the periphery of the opening of the flat trumpet shaped cavity inside the optical field cover; a ring baffle is extended outwards from the embedding portion; the ring baffle is provided with a plurality of second hollow columns facing the back shell; the periphery of the first window inside the front shell is provided with a plurality of second pins; when the embedding portion of the optical field cover is embedded into the first window, the plurality of second pins is correspondingly inserted into the centre hole of the plurality of second hollow columns.

The optical field cover also can form a plastic member with the front shell directly through injection technique.

The back shell and the front shell of the disclosure preferably adopt the member made of uvioresistant aging-resistant reinforced and toughened plastic; the optical field cover preferably adopts the member made of white uvioresistant aging-resistant reinforced and toughened plastic which does not absorb light.

Since the disclosure applies the radiating device of the special structure above, the heat dissipation effect is good, the weight is greatly reduced and the volume is reduced. According to the experiment, when applying a 50-watt high-power single polycrystalline LED chip module, the LED street lamp of the disclosure only needs a radiator less than 1.8 Kg; when applying a 100-watt high-power single polycrystalline LED chip module, the LED street lamp of the disclosure only needs a radiator less than 3.5 Kg; however, the radiator of the present 100-watt LED street lamp adopts an aluminium block or an aluminium alloy shell of more than 10 Kg to radiate heat.

By using a high-power single polycrystalline LED chip module as a light source and close cooperating with an optical field cover and a single light scattering lens without interspaces, the disclosure can achieve the requirement of the street lamp of bat wing shaped rectangle light distribution curve of an optical field using a primary light source, the brightness uniformity is 40% higher than the upper limit of the standard required value and the illumination effect is good, thus the problem of luminous efficiency loss caused by the conventional design scheme adopting the second light source or the third light source is avoided. The structure is simple, the maintenance is simple too, just like the conventional high pressure sodium lamp, only simple maintenance is needed.

The radiator is designed by modularization, thus the radiator module is singularized and it is unnecessary to develop a radiator module for each type of LED with a different power; therefore, the expense of module is saved. The arc radiator is directly mounted on the back surface of the shell, with small volume and beautiful appearance. The mounting screws of the radiating device and optical field cover all are located inside the shell and would not be rusted due to raining.

By adopting the shell consisting of a back shell of uvioresistant aging-resistant reinforced and toughened plastic and a front shell of uvioresistant aging-resistant reinforced and toughened plastic, the weight of the entire lamp cap (not containing the mounting plate and constant-current supply) can be reduced greatly, for example, the weight of the 100-watt street lamp with high-power single polycrystalline LED chip module is less than 5 Kg, thus the street lamp is safer in typhoon or earthquake and is difficult to fall onto the ground to cause harm. However, the lamp cap adopting an aluminium alloy shell to radiate heat is very heavy generally, for example, the entire weight of the entire 100-watt LED street lamp is more than 10 Kg.

### BRIEF DESCRIPTION OF THE DRAWINGS

FIG. 1 shows a front viewing stereogram of an LED street lamp of a typical embodiment;

FIG. 2 shows a back viewing stereogram of an LED street lamp of a typical embodiment;

FIG. 3 shows an exploded view of an LED street lamp of a typical embodiment;

FIG. 4 shows a stereogram of a combination of a radiating device, a back shell and an LED module of an LED street lamp of a typical embodiment;

FIG. 5 shows a structure diagram of a super heat-conductive pipe of an LED street lamp of a typical embodiment;

FIG. 6 and FIG. 7 show a structure diagram of a radiator member of an LED street lamp of a typical embodiment.

### DETAILED DESCRIPTION OF THE INVENTION

The disclosure is further described below in conjunction with accompanying drawings.

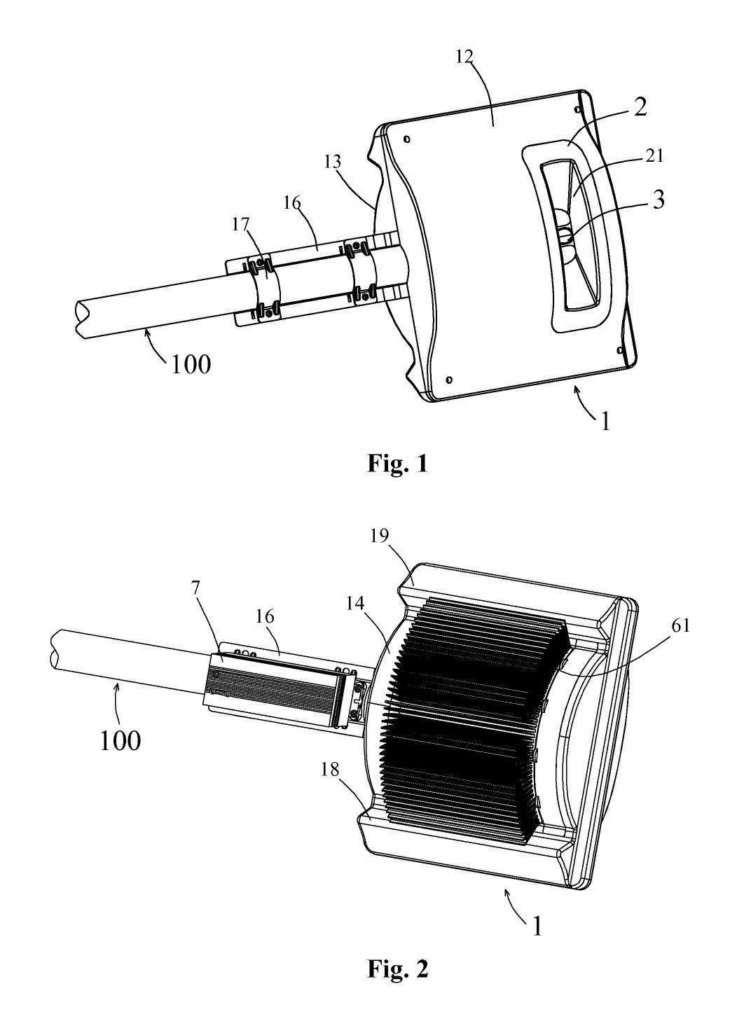

As shown in FIG. 1 to FIG. 7, the LED street lamp comprises a shell 1, a optical field cover 2, a light scattering lens 3, a high-power single polycrystalline LED chip module 4 and a radiating device 6 with a connection frame, in the Figures, 100 represents a street lamp post.

The shell 1 consists of a back shell 13 and a front shell 12, wherein the front shell 12 is provided with a first window 11, the middle part of the back shell 13 is a circular arched portion 14 protruding outwards and the circular arched portion 14 is provided with a second window 15; one end of the back shell 13 is provided with a mounting plate 16, wherein the LED street lamp is fastened on the street lamp post 100 through the mounting plate 16 and a lower clamp 17; a constant-current supply 7 is mounted on the mounting plate 16 for the high-power single polycrystalline LED chip module to use; two sides of the circular arched portion 14 on the back shell 13 are provided with two reinforcement protruding parts 18, 19, wherein the sections of the reinforcement protruding parts 18, 19 are in inverse V shape or circular arc shape, and a plurality of reinforcement plates 18′ are arranged inside the inner cavity.

The shell 1 can be made of plastic, with light weight. In order to adapt to outside use and prevent the degrading and aging of the plastic shell caused by ultraviolet irradiation, the back shell and the front shell above preferably are made of uvioresistant aging-resistant reinforced and toughened plastic, wherein the addition amount of the ultraviolet absorbent is about 3% of the total weight of a finished part; the ultraviolet absorbent can adopt light stabilizer HPT (Hexamethylphosphoric Triamide), UV-9 (Oxybenzone) and so on.

The optical field cover 2 mainly comprises a fan shaped body 20, wherein a flat trumpet shaped inner cavity 21 with openings at two ends is provided inside the fan shaped body 20; the optical field cover 2 is mounted on the first window 11 inside the shell 12 of the shell 1, and a light scattering lens 3 is mounted in the opening at the bottom of the flat trumpet shaped cavity 21 (that is, the opening at the bottom of the optical field cover 2); likewise, in order to adapt to outdoor use and prevent the degrading and aging of the plastic optical field cover, the optical field cover is preferably made of white uvioresistant aging-resistant reinforced and toughened plastic which does not absorb light.

The light scattering lens 3 is a solid lens using a flat bottom surface as a light incident surface and is mounted in the opening at the inner bottom of the optical field cover 2. The light scattering lens 3 comprises a base 30 of which the lower bottom surface is a flat surface and is used as a light incident surface; a convex portion which is located on the base 30 and comprises a middle part 32 and two partial ball parts 31, 37 symmetrically set on two ends of the middle part 32, wherein the refraction spherical surface of the two partial ball parts and the refraction arc surface of the middle part are in smooth connection; and two reflection planes 34, 35 both of which are symmetrically set in the upper middle part of the middle part 32 and are inclined towards the adjacent partial ball part respectively so as to reflect partial light emitted into the lens from the lower bottom surface onto the refraction spherical surface of the adjacent partial ball part to emit out. The roots of the two reflection planes 34, 35 are provided with two shading planes respectively. The light scattering lens 3 can directly make the light source emitted from the single polycrystalline LED chip module form the bat wing shaped rectangle light distribution curve of an optical field required by the street lamp. The light scattering lens is preferably made of glass, PC (Polycarbonate), PMMA (polymethyl methacrylate) and other transparent materials with good performance.

The high-power single polycrystalline LED chip module 4 comprises a chip set, a solid crystal substrate, fluorescence silica gel and so on. The surface of the module 4 is close jointed to the flat bottom surface (that is, light incident surface) of the light scattering lens 3 inside the shell through silica gel without interspaces. The disclosure can adopt the LED module for various street lamps on the market, for example, WG-P100WLED module produced by Shenzhen Lantian Weiguang Electronics Corporation, GT-P100WW6410001006A type LED module produced by Getian Optoelectronics Corporation, or self-produced rectangular high-power single polycrystalline LED chip module.

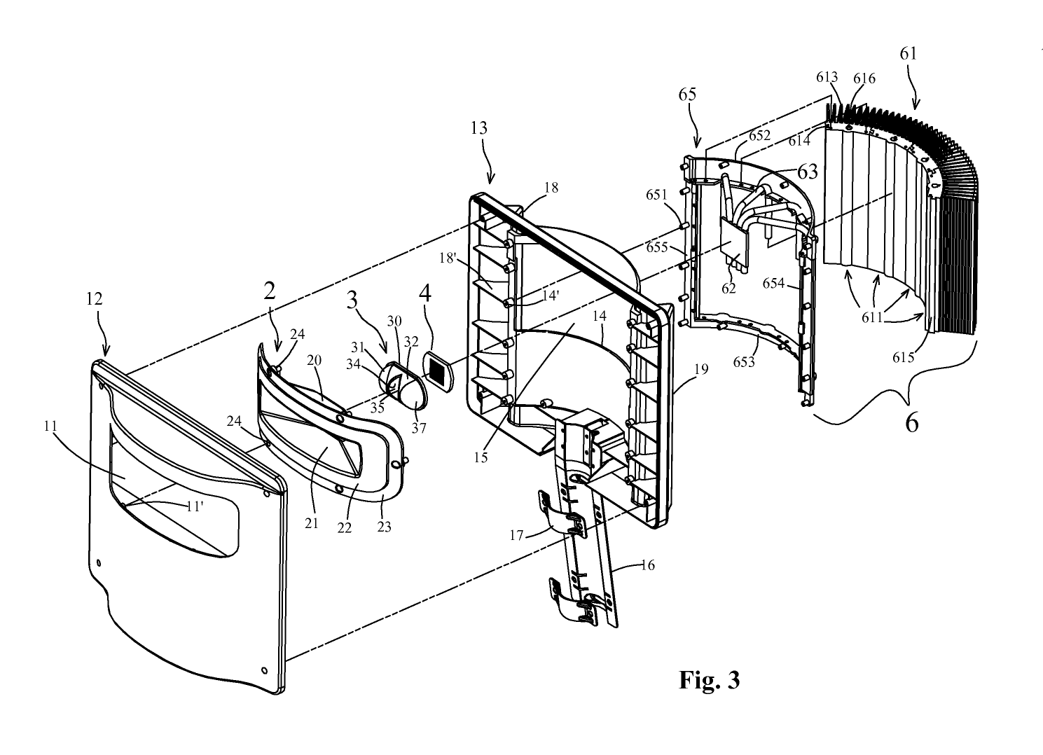

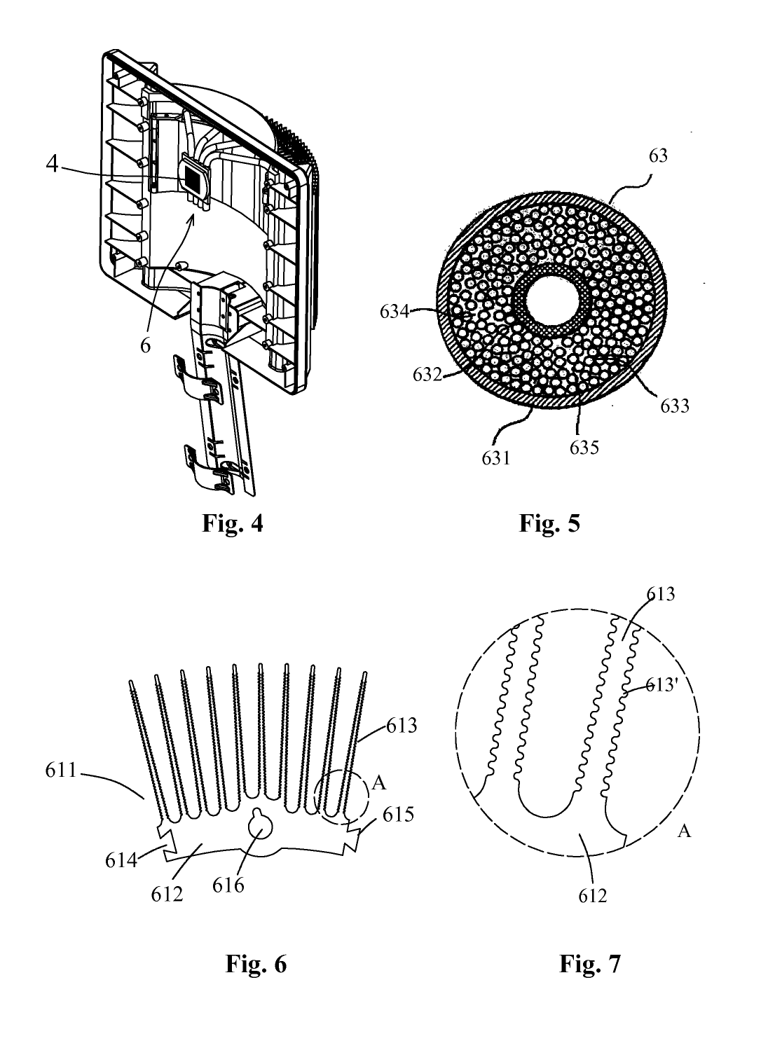

Referring to FIG. 3 and FIG. 4, the radiating device 6 comprises a radiator 61, a heat-conductive component 62 and at least one super heat-conductive pipe 63, in which, the radiator 61 is an arc radiator made of aluminium material, wherein the outside arc surface is covered with radiating fins 613 in a divergent shape; the radiator 61 is provided with a heat-conductive pipe mounting hole 616 and is mounted on the second window 15 of the circular arched portion 14 in the middle part of the back shell 13. Since the radiator 61 adopts an arc design, on one hand, the space occupied by the radiator can be reduced, on the other hand, the distance between adjacent radiating fins is increased in the premise of not enlarging the radiator and not reducing the number of radiating fins, thus, it is good for the dissipation of heat. The heat-conductive component 62 is made of a metal with high heat conductivity (for example, copper or aluminium), wherein one side thereof is provided with a heat-conductive mounting hole. The heat-conductive component 62 is in close contact with the back surface of the single polycrystalline LED chip module 4, wherein a heat-conductive medium, for example, silica gel, is coated between the heat-conductive component 62 and the back surface of the single polycrystalline LED chip module 4.

The super heat-conductive pipe 63 is in horizontal U shape, with two ends tightly inserted and welded into the heat-conductive mounting hole on the heat-conductive component 62 and the heat-conductive mounting hole 616 on the arc radiator 61 respectively, to realize the heat conduction from the heat-conductive component 62 to the arc radiator 61; a plurality of super heat-conductive pipes 63 are placed inside the second window 15 of the back shell 13 through the arc radiator 61.

Referring to FIG. 5, the super heat-conductive pipe 63 can adopt the super heat-conductive pipe of the following structure, wherein the super heat-conductive pipe comprises a metal outer pipe 631, a thin metal net 632 coiled inside the metal outer pipe 631, a plurality of thin metal balls 633 arranged between the outer pipe 631 and the thin metal net 632 so that the plurality of thin metal balls 633 form a barrel shaped structure with ring section, the thickness of the barrel wall of the barrel shaped structure being 25%-40% of the inner diameter of the metal outer pipe 631, a super conductive mixed liquid 634, wherein the metal outer pipe 631, the thin metal net 632 and the plurality of thin metal balls 633 form a conductor pipe with vacuum, no gravity and no pressure after being sintered and vacuum processed; a super conductive mixed liquid 634 is filled in the conductor pipe to form a super heat-conductive pipe with vacuum and super conductive fast transfer characteristics. In the super heat-conductive pipe 63, since a thick-wall barrel shaped structure with ring section formed by a large number of thin metal balls 633 is provided, since the metal outer pipe 631, the interspaces of the thin metal net 632, the surface of the thin metal net 632 and the surface of the plurality of thin metal balls 633 form a distribution surface film 635 of the super conductive mixed liquid, wherein under the condition of vacuum, no gravity and no pressure, the super conductive mixed liquid 634 enables the thermal energy of one end of hot junction to be quickly transferred to the cold end unidirectionally by using the mutual pushing movement of the distribution surface film 635; besides, the super heat-conductive pipe 63 can be configured in any angle and direction to avoid the backflow angle restriction of the heat-conductive pipe of the backflow circulation caused by hot gas rising (for example, the angle restriction of the heating end being in upper side and the radiating end being in lower side) and adapt to the configuration application of multi-directionality, wherein the metal outer pipe 631, the thin metal net 632 and the thin metal balls 633 are made of copper or aluminium material. The super conductive mixed liquid 634 can be formed by mixing several different super conductive liquid materials in proportion, wherein the super conductive liquid material preferably applies the super conductive mixed liquid formed by mixing NaOH, K₂CrO₄, ethanol and water (H₂O) in proportion, also can apply other known super conductive liquid materials.

In actual application, LED street lamps with different powers are needed; however, the size of the radiator needed by the LED street lamp with different powers is different; in this way, different modules are needed to manufacture the radiator; thus, the cost of development is increased. In view of the problem above, the arc radiator of the disclosure applies a modularization design idea and a radiator member is designed; one or more radiator members can be combined to form an arc radiator suitable for the street lamp with different powers, thus the radiator module is singularized and it is unnecessary to develop a radiator module for each type of LED with a different power; therefore, the expense of module is saved. In the embodiment above, the arc radiator 61 consists of four radiator members 611; referring to FIG. 6, each radiator member 611 comprises an arc plate 612, wherein a plurality of spaced radiating fins 613 is extended outwards from the outside arc surface of the arc plate 612; a vertical end face of the arc plate 612 is provided with a connection groove 614 along the longitudinal direction while the other vertical end face is provided with a connection protruded strip 615 along the longitudinal direction; at least one heat-conductive pipe mounting hole 616 is set on the arc plate 612 along the longitudinal direction. In FIG. 6, the connection protruded strip 615 of the arc plate 612 is a protruded strip with trapezoidal section of the connection protruded strip 615; correspondingly, the connection groove 614 of the arc plate 612 is a trapezoidal groove. The connection protruded strip 615 of the arc plate 612 also can be made as a columnar protruded strip; the connection groove 614 of the arc plate 612 is made as a circular arc groove. The connection protruded strip 615 and the connection groove 614 of the arc plate 612 also can be made as other shapes, only if two radiator members can be connected into one.

In FIG. 7, the radiating fin 613 has a thick bottom and a thin top and having protruding strips 613′ covered on the surface. In this way, the superficial area of the radiating fin is greatly increased, thus the heat dissipation efficiency is greatly improved. Since the radiating fin has a thick bottom and a thin top, the distance between the adjacent radiating fins can be further increased, thus the air circulation between radiating fins is increased and the heat dissipation is accelerated.

Referring to FIG. 3 and FIG. 4, the connection frame 65 is used for connecting the radiating device 6 and the back shell 13, wherein the connection frame 65 is fixedly mounted in the periphery of the arc plate of the radiator 61; the lower end face of the connection frame 65 is provided with a plurality of first downward pins 651 at intervals; the periphery of the circular arched portion 14 inside the back shell 13 is provided with a plurality of first hollow columns 14′ for accommodating and mounting the corresponding first pins 651 of the connection frame. Upon assembly, the connection frame 65 is in close contact with the arched portion 14 of the back shell 13; the plurality of first pins 651 on the connection frame 65 is correspondingly inserted into the plurality of first hollow columns 14′ of the back shell 13, wherein screws are screwed into the centre hole of first pins 651 of the connection frame at the bottom end of the first hollow column 14′ to fasten the arc radiator 61 onto the back shell 13; in this way, the mounting screws all are located inside the shell 1 and would not be rusted due to raining. The connection frame 65 comprises a U shaped frame and an upper arc border 652, in which, the U shaped frame is an integrated component formed by two straight borders 654, 655 and an arc border 653 connecting the two straight borders, wherein the two straight borders are connected with the connection protruded strips or the connection grooves of two end faces of the arc radiator 61 through the connection groove or connection protruded strip respectively; the upper arch border 652 and the arc border 653 are screwed on the two arc end faces of the arc radiator 61 respectively.

Upon assembly, the arc radiator 61, the super heat-conductive pipe 63 and the heat-conductive component 62 are assembled first; then the radiator 61 is slid into the U shaped frame so as to connect the straight border 654 through the connection groove and the connection protruding strip 615 on one end face of the arc radiator 61 (in FIG. 3, the right end face of a right radiator member 611) and connect the straight border 655 through the connection protruding strip and the connection groove 614 on one end face of the arc radiator 61 (in FIG. 3, a left end face of a left radiator member 611); the arc border 653 is fastened with the radiator member 611 without the heat-conductive pipe by screw; then the arc border 652 is clamped; screws are screwed into the straight borders 654, 655 to fasten, meanwhile, the arc end face 652 is fastened on the upper arc end face of the arc radiator 61 through screws, then the combination of the arc radiator and the connection frame is finished. Since the heat-conductive pipe hole site corresponding to the arc border 652 is in a shape of trench, the arc border 652 can be assembled from top down; the connection frame 65, like the back shell and the front shell, preferably is made of uvioresistant aging-resistant reinforced and toughened plastic.

An embedding portion 22 matched with the first window 11 is extended outwards from the periphery of the outer opening of the flat trumpet shaped cavity 21 inside the optical field cover 2; a ring baffle 23 is extended outwards from the embedding portion 22; the ring baffle 23 is provided with a plurality of second hollow columns 24 facing the back shell 13; the periphery of the first window 11 inside the front shell 12 is provided with a plurality of second pins 11′; when the embedding portion 22 of the optical field cover 2 is embedded into the first window 11 of the front shell 12, the plurality of second pins 11′ is correspondingly inserted into the centre hole of the plurality of second hollow columns 24, wherein screws can be used to realize the combination of the optical field cove and the shell. With the structure above, no screw will be exposed outside the shell, thus the defect of screw being rusted due to raining is overcome. The embedding portion 22 and the baffle 23 of the optical field cover 2 are of arc shape or plane shape. The length-width ratio of the outside opening of the flat trumpet shaped inner cavity 11 of the optical field cover 2 is 5:1, 4:1 or 3:1 to accord with the rectangular optical field shape required by street lamp standard. The optical field cover 2 also can form a plastic member with the front shell 12 directly through injection technique.

According to the experiment, the measured temperature of the LED substrate of the LED street lamp is about 52 degrees in the 25-degree constant temperature environment of dry air and windless condition, while the luminous attenuation temperature of the LED module is 82 degrees, the measured temperature of the LED substrate is about 30 degrees lower than the luminous attenuation temperature of the LED module.

The street lamp with high-power single polycrystalline LED chip module of the disclosure only needs a radiator less than 1.8 Kg for 50 watts and a radiator less than 3.5 Kg for 100 watts; however, for a present 100-watt LED street lamp, the radiator needs an aluminium block or a aluminium alloy lamp housing more than 10 Kg; thus the weight of the radiator is reduced by about ⅔ in the disclosure.

It can be seen from the above that the street lamp with high-power single polycrystalline LED chip module of the disclosure not only can control the heating temperature of the LED street lamp (or the temperature of the LED substrate) below the luminous attenuation temperature point and prolong the service life of the LED street lamp effectively, but also can greatly save aluminium material and reduce weight to achieve the purpose of safety and cost reduction, and further can take simple maintenance into account during maintenance, which is as convenient as the conventional high pressure sodium lamp.

What is claimed is:

1. A street lamp with high-power single polycrystalline Light-Emitting Diode (LED) chip module, comprising
a shell composed of a back shell and a front shell, wherein the front shell is provided with a first window, the middle part of the back shell is a circular arched portion protruding outwards and the arched portion is provided with a second window;
an optical field cover, which is mounted on the first window inside the shell or forms a plastic member with the front shell directly through injection technique and comprises a fan shaped body, wherein a flat trumpet shaped cavity with openings at two ends is provided inside the fan shaped body;
a high-power single polycrystalline LED chip module;
a light scattering lens mounted in the opening at the inner bottom of the optical field cover, wherein the light scattering lens is a solid lens using a flat bottom surface as a light incident surface, and the bottom surface is close jointed to the silica gel on the surface of the high-power single polycrystalline LED chip module without interspaces, so as to form a bat wing shaped rectangle light distribution curve of an optical field using a primary light source; and
a radiating device, which comprises
an arc radiator mounted on the arched portion of the back shell, with radiating fins covered on an outside arc surface in a divergent shape;
a heat-conductive component in close contact with the back surface of the high-power single polycrystalline LED chip module; and
at least one super heat-conductive pipe located inside the second window of the shell, with two ends respectively connected with the heat-conductive component and the arc radiator.

2. The street lamp according to claim 1, wherein the radiating device further comprises a connection frame fixedly mounted surrounding the arc plate of the arc radiator; the lower end face of the connection frame is provided with a plurality of first downward pins at intervals; the periphery of the circular arched portion inside the back shell is provided with a plurality of first hollow columns for accommodating and mounting the corresponding first pins on the connection frame.

3. The street lamp according to claim 2, wherein the connection frame comprises a U shaped frame and an upper arc border, in which, the U shaped frame is an integrated component formed by two straight borders and an arc border connecting the two straight borders, wherein the two straight borders are connected with the connection protruded strips or connection grooves of two end faces of the arc radiator through the connection groove or connection protruded strip respectively; the upper arch border and the arc border are screwed on the two arc end faces of the arc radiator respectively.

4. The street lamp according to claim 2, wherein the super heat-conductive pipe of the radiating device comprises: a metal outer pipe, a thin metal net coiled inside the metal outer pipe, a plurality of thin metal balls arranged between the outer pipe and the thin metal net so that the plurality of thin metal balls form a barrel shaped structure with ring section, the thickness of the barrel wall of the barrel shaped structure being 25%-40% of the inner diameter of the metal outer pipe, a super conductive mixed liquid, and a distribution surface film of the super conductive mixed liquid formed by the metal outer pipe, the interspaces of the thin metal net, the surface of the thin metal net and the surface of the plurality of thin metal balls; wherein the formed distribution surface film of the super conductive mixed liquid, under the condition of vacuum, no gravity and no pressure, enables the thermal energy of one end of hot junction to be quickly transferred to the cold end unidirectionally by using the mutual pushing movement of the distribution surface film.

5. The street lamp according to claim 1, wherein the arc radiator consists of at least one radiator member, each radiator member including an arc plate, wherein a plurality of spaced radiating fins is extended outwards from the outside arc surface of the arc plate; a vertical end face of the arc plate is provided with a connection groove along the longitudinal direction while the other vertical end face is provided with a connection protruded strip along the longitudinal direction; at least one heat-conductive pipe mounting hole is set on the arc plate along the longitudinal direction.

6. The street lamp according to claim 1, wherein the super heat-conductive pipe of the radiating device comprises: a metal outer pipe, a thin metal net coiled inside the metal outer pipe, a plurality of thin metal balls arranged between the outer pipe and the thin metal net so that the plurality of thin metal balls form a barrel shaped structure with ring section, the thickness of the barrel wall of the barrel shaped structure being 25%-40% of the inner diameter of the metal outer pipe, a super conductive mixed liquid, and a distribution surface film of the super conductive mixed liquid formed by the metal outer pipe, the interspaces of the thin metal net, the surface of the thin metal net and the surface of the plurality of thin metal balls; wherein the formed distribution surface film of the super conductive mixed liquid, under the condition of vacuum, no gravity and no pressure, enables the thermal energy of one end of hot junction to be quickly transferred to the cold end unidirectionally by using the mutual pushing movement of the distribution surface film.

7. The street lamp according to claim 6, wherein the super conductive liquid adopts the super conductive mixed liquid formed by mixing NaOH, K₂CrO₄, ethanol and water in proportion.

8. The street lamp according to claim 1, wherein an embedding portion matched with the first window is extended outwards from the periphery of the opening of the flat trumpet shaped cavity inside the optical field cover; a ring baffle is extended outwards from the embedding portion; the ring baffle is provided with a plurality of second hollow columns facing the back shell; the periphery of the first window inside the front shell is provided with a plurality of second pins; when the embedding portion of the optical field cover is embedded into the first window of the front shell, the plurality of second pins is correspondingly inserted into the centre hole of the plurality of second hollow columns.

9. The street lamp according to claim 8, wherein the length-width ratio of the outside opening of the flat trumpet shaped cavity of the optical field cover is 5:1, 4:1 or 3:1.

10. The street lamp according to claim 1, wherein the length-width ratio of the outside opening of the flat trumpet shaped cavity of the optical field cover is 5:1, 4:1 or 3:1.

11. The street lamp according to claim 1, wherein the light scattering lens comprises:
a base of which the lower bottom surface is a flat surface and is used as a light incident surface; a convex portion which is located on the base and comprises a middle part and two partial ball parts symmetrically set on two ends of the middle part, wherein the refraction spherical surfaces of the two partial ball parts and the refraction arc surface of the middle part are in smooth connection; and two reflection planes both of which are symmetrically set in the upper middle part of the middle part and are inclined towards the adjacent partial ball part respectively so as to reflect partial light emitted into the lens from the lower bottom surface onto the refraction spherical surface of the adjacent partial ball part to emit out.

12. The street lamp according to claim 11, wherein the roots of the two reflection planes are provided with shading planes respectively.

13. The street lamp according to claim 1, wherein the back shell and the front shell adopt the member made of uvioresistant aging-resistant reinforced and toughened plastic; the optical field cover adopts the member made of white uvioresistant aging-resistant reinforced and toughened plastic which does not absorb light.

14. The street lamp according to claim 13, wherein two protruding parts are provided on two sides of the circular arched portion on the back shell; the section of the protruding part is in inverse V shape or circular arc shape; a plurality of reinforcement plates is arranged inside the inner cavity.

15. The street lamp according to claim 1, wherein two protruding parts are provided on two sides of the circular arched portion on the back shell; the section of the protruding part is in inverse V shape or circular arc shape; a plurality of reinforcement plates is arranged inside the inner cavity.
